(19) United States
(12) Patent Application Publication
(10) Pub. No.: US 2015/0370744 A1
(43) Pub. Date: Dec. 24, 2015

(54) COMPOSITE STORAGE DEVICE AND COMPOSITE MEMORY THEREOF

(71) Applicant: APACER TECHNOLOGY INC., New Taipei City (TW)

(72) Inventor: Jiunn-Chang Lee, New Taipei City (TW)

(21) Appl. No.: 14/486,160

(22) Filed: Sep. 15, 2014

(30) Foreign Application Priority Data
Jun. 24, 2014 (TW) 103121753

(51) Int. Cl. G06F 13/40; G06F 1/26

(52) U.S. Cl. CPC G06F 13/4081; G06F 1/266

(57) ABSTRACT

A composite storage device comprises a storage device and a composite memory, which comprises a substrate, a first transmission interface, a storage unit, a power conversion unit, a card insertion interface and a second transmission interface. The first transmission interface is coupled with a first communication interface of a main circuit board, and the second transmission interface is coupled with a second communication interface of the main circuit board via a transmission channel. The power conversion unit is coupled with the first transmission interface and the card insertion interface. The card insertion interface is coupled with the second transmission interface. When the storage device is electrically connected with the card insertion interface, the power is provided to the storage device, and information is exchanged between the storage device and the main circuit board through the card insertion interface, the second transmission interface, the transmission channel and the second communication interface.

### TECHNICAL FIELD

The present disclosure relates to a composite storage device, and more particularly to a composite storage device including a volatile storage unit and a detachable non-volatile storage device.

### BACKGROUND OF THE DISCLOSURE

With the progress of the computer related technologies, lots of information used in daily life is urged toward digitation. Many different kinds of media we used in the past, such as photos for preserving images, disks for recording music, or films for playing movies, are now replaced by data in digital form that stored in computers. That is, storage devices which are capable of storing digital data have become essential media in our daily life.

The hard-disk drive (HDD) is known as a non-volatile storage device for preserving digital data in a long period of time. Due to the obstacle in design and operation of the mechanical structure, it is hard to decrease the size of HDD any further. As the development of the flash memory in recent years, HDD has been gradually replaced by solid-state disk (SSD) because SSD is lighter and thinner than HDD, and also has an advantage of low power consumption. However, it is known that only 2.5-inch or 3.5-inch storage devices can be mounted in general personal computers (PCs). Since many of the card-form SSDs or the module-form SSDs are unable to be mounted in the personal computers (PCs), it is quite inconvenient for user to mount the card-form SSDs or the module-form SSDs in the general PCs.

Therefore, there is a need of providing a composite storage device in order to eliminate the above drawbacks.

### SUMMARY OF THE DISCLOSURE

The present disclosure provides a composite storage device and a composite memory thereof. By integrating a SSD with a DRAM, the SSDs with different kinds of interface specifications can be installed on the main circuit board of the computer through the current interfaces available on the main circuit board without adding any new interfaces on the main circuit board. Consequently, the facilities of utilizing and mounting the SSDs are improved, and the cost is reduced.

The present disclosure provides a composite storage device and a composite memory thereof. By employing the composite storage device and the composite memory of the present invention, various card-form SSD or module-form SSD can be installed on the main circuit board, and the required electric energy can be provided to the non-volatile storage device and the dynamic random access memory for operations at the same time via a single interface of the main circuit board. Consequently, the mounting space is reduced, and the size of the product can be further reduced.

In accordance with an aspect of the present disclosure, there is provided a composite storage device. The composite storage device comprises a storage device and a composite memory. The composite memory comprises a substrate, a first transmission interface, a storage unit, a power conversion unit, a card insertion interface and a second transmission interface. The first transmission interface is disposed on the substrate and configured to connect with a first communication interface of a main circuit board. The storage unit is disposed on the substrate and coupled with the first transmission interface, and the information exchanged between the storage unit and the main circuit board is performed through the first transmission interface and the first communication interface of the main circuit board. The power conversion unit is disposed on the substrate and electrically coupled with the first transmission interface for converting a first power provided from the main circuit board to a second power. The card insertion interface is disposed on the substrate and coupled with the power conversion unit. The second transmission interface is disposed on the substrate and coupled with the card insertion interface, and the second transmission interface is connected with a second communication interface of the main circuit board through a transmission channel. The storage device is detachably connected with the card insertion interface of the composite memory. When the storage device is electrically connected with the card insertion interface, the second power is provided to the storage device for operations through the card insertion interface, and the information is exchanged between the storage device and the main circuit board through the card insertion interface, the second transmission interface, the transmission channel and the second communication interface.

In accordance with another aspect of the present disclosure, there is provided a composite memory for detachably connecting with a storage device and a main circuit board including a first communication interface and a second communication interface. The composite memory comprises a substrate, a first transmission interface, a storage unit, a power conversion unit, a card insertion interface and a second transmission interface. The first transmission interface is disposed on the substrate and configured to connect with the first communication interface of the main circuit board. The storage unit is disposed on the substrate and coupled with the first transmission interface, and the information exchanged between the storage unit and the main circuit board is performed through the first transmission interface and the first communication interface of the main circuit board. The power conversion unit is disposed on the substrate and electrically coupled with the first transmission interface for converting a first power provided from the main circuit board to a second power. The card insertion interface is disposed on the substrate and coupled with the power conversion unit for detachably connecting with the storage device. The second transmission interface is disposed on the substrate and coupled with the card insertion interface, and the second transmission interface is connected with the second communication interface of the main circuit board through a transmission channel. When the storage device is electrically connected with the card insertion interface, the second power is provided to the storage device through the card insertion interface, and the information is exchanged between the storage device and the main circuit board through the card insertion interface, the second transmission interface, the transmission channel and the second communication interface.

In accordance with a further aspect of the present disclosure, there is provided a composite storage device. The composite storage device comprises at least one storage device and a composite memory. The composite memory comprises a substrate, a first transmission interface, a storage unit, a power conversion unit, a first card insertion interface, a second card insertion interface, a second transmission interface and a third transmission interface. The first transmission interface is disposed on the substrate and configured to connect with a first communication interface of a main circuit board. The storage unit is disposed on the substrate and coupled with the first transmission interface, and the information exchanged between the storage unit and the main circuit board is performed through the first transmission interface and the first communication interface of the main circuit board. The power conversion unit is disposed on the substrate and coupled with the first transmission interface for converting a first power provided from the main circuit board to a second power and a third power. The first card insertion interface is disposed on the substrate and coupled with the power conversion unit. The second card insertion interface is disposed on the substrate and coupled with the power conversion unit. The second transmission interface is disposed on the substrate and coupled with the first card insertion interface, and the second transmission interface is connected with a second communication interface of the main circuit board through a first transmission channel. The third transmission interface is disposed on the substrate and coupled with the second card insertion interface, and the third transmission interface is connected with a third communication interface of the main circuit board through a second transmission channel. Each storage device is detachably connected with one of the first card insertion interface and the second card insertion interface. When the storage device is electrically connected with the first card insertion interface, the second power is provided to the storage device for operations through the first card insertion interface, and the information is exchanged between the storage device and the main circuit board through the first card insertion interface, the second transmission interface, the first transmission channel and the second communication interface. When the storage device is electrically connected with the second card insertion interface, the third power is provided to the storage device for operations through the second card insertion interface, and the information is exchanged between the storage device and the main circuit board through the second card insertion interface, the third transmission interface, the second transmission channel and the third communication interface.

### BRIEF DESCRIPTION OF THE DRAWINGS

FIG. 1 schematically illustrates a composite storage device according to an embodiment of the present invention; and

FIG. 2 schematically illustrates a composite storage device according to another embodiment of the present invention.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

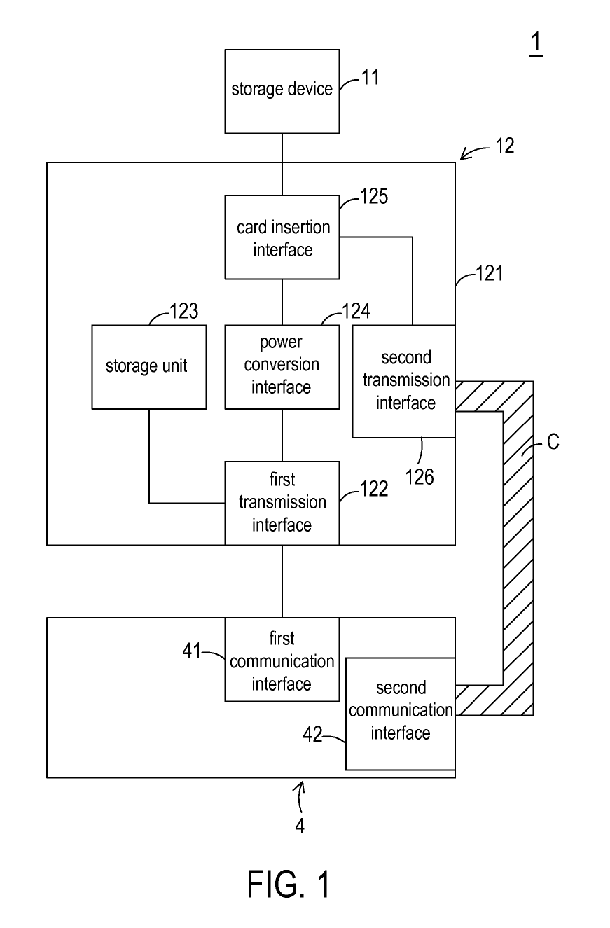

FIG. 1 schematically illustrates a composite storage device according to an embodiment of the present invention. Please refer to FIG. 1. The composite storage device 1 comprises a storage device 11 and a composite memory 12. In this embodiment, the storage device 11 is a non-volatile storage device. Preferably, the storage device 11 is a SSD, and the SSD may be conformed to an mSata interface specification, an M.2 interface specification or a CFast card interface specification, but it is not limited thereto.

Please refer to FIG. 1 again. The composite memory 12 is detachably connected with the storage device 11 and a main circuit board 4 of a computer. The composite memory 12 comprises a substrate 121, a first transmission interface 122, a storage unit 123, a power conversion unit 124, a card insertion interface 125 and a second transmission interface 126. The main circuit board 4 comprises a first communication interface 41 and a second communication interface 42. Moreover, the first transmission interface 122, the storage unit 123, the power conversion unit 124, the card insertion interface 125 and the second transmission interface 126 are all disposed on the substrate 121 and electrically connected with one another through traces of the substrate 121. In this embodiment, the first transmission interface 122 of the composite memory 12 and the first communication interface 41 of the main circuit board 4 are conformed to a dual in-line memory module (DIMM) interface specification. Consequently, the composite memory 12 can be directly installed on the main circuit board 4, and the first transmission interface 122 of the composite memory 12 is connected with the first communication interface 41 of the main circuit board 4.

Besides, as shown in FIG. 1, the storage unit 123 is coupled with the first transmission interface 122. That is, the required power for operating the storage unit 123 provided from the main circuit board 4 is transmitted to the storage unit 123 through the first transmission interface 122 and the first communication interface 41 of the main circuit board 4. Also, information is able to be exchanged between the storage unit 123 and the main circuit board 4 through the first transmission interface 122 and the first communication interface 41 of the main circuit board 4. In this embodiment, the storage unit 123 is a volatile storage unit, which is securely mounted on the substrate 121. After the composite memory 12 is installed into the first communication interface 41 of the main circuit board 4 through its first transmission interface 122, the storage unit 123 would be regarded as a random access memory (RAM) of the computer.

The power conversion unit 124 is electrically coupled with the first transmission interface 122 and the card insertion interface 125, and the power conversion unit 124 is electrically connected with the main circuit board 4 through the first transmission interface 122 and the first communication interface 41 of the main circuit board 4. Under this circumstances, a first power provided from the main circuit board 4 can be converted to a second power which is conformed to the specification of the card insertion interface 125 by the power conversion unit 124. For example, portion of the electric energy provided from the main circuit board 4 is transmitted to the power conversion unit 124 through the first communication interface 41 and the first transmission interface 122 of the composite memory 12, and the voltage level of the power provided from the main circuit board 4 can be boosted or reduced to a required voltage level for example 3.3 volts by the power conversion unit 124. After the voltage level of the power has been converted to the required voltage level, the power is transmitted to the card insertion interface 125 to be outputted.

The second transmission interface 126 is disposed on the substrate 121 of the composite memory 12 and coupled with the card insertion interface 125. The second transmission interface 126 of the composite memory 12 is connected with the second communication interface 42 of the main circuit board 4 through a transmission channel C. In this embodiment, the second transmission interface 126 of the composite memory 12 and the second communication interface 42 of the main circuit board 4 may be conformed to a serial ATA (SATA) interface specification, but it is not limited thereto. For example, the second transmission interface 126 is an edge connector (i.e. golden finger) disposed on one side edge of the substrate 121, the second communication interface 42 is a socket, and the transmission channel C is a cable that is conformed to a SATA interface specification. Two mating connectors of the cable are connected with the second transmission interface 126 of the composite memory 12 and the second communication interface 42 of the main circuit board 4, respectively (not shown in FIG. 1). Consequently, data transmission between the composite memory 12 and the main circuit board 4 is performed through the cable.

In this embodiment, as shown in FIG. 1, the storage device 11 is detachably connected with the card insertion interface 125 of the composite memory 12 to form an electrical connection. The card insertion interface 125 may be conformed to an mSATA interface specification, an M.2 interface specification or a CFast card interface specification, but it is not limited thereto. That is, taking the card insertion interface 125 conformed to the mSATA interface specification for example, the SSD which is also conformed to the mSATA interface specification can be installed into the card insertion interface 125 through a mating connector thereof by users. Similarly, if the card insertion interface 125 is conformed to the M.2 interface specification or the CFast card interface specification, a SSD with the same interface specification as the card insertion interface 125 can be installed into the card insertion interface 125 through a mating connector thereof.

Please refer to FIG. 1 again. When the storage device 11 is electrically connected with the card insertion interface 125 of the composite memory 12, the second power, which is converted by the power conversion unit 124 and conformed to the interface specification of the card insertion interface 125, is outputted to the storage device 11 through the card insertion interface 125. Under this circumstances, the required electric energy can be provided to the storage device 11 for operations. In addition, when the storage device 11 is electrically connected with the card insertion interface 125, the storage device 11 is connected with the main circuit board 4 through the card insertion interface 125, the second transmission interface 126, the transmission channel C and the second communication interface 42 of the main circuit board 4. Under this circumstances, information exchanged between the storage device 11 and the main circuit board 4 is performed via the transmission path of the card insertion interface 125, the second transmission interface 126, the transmission channel C and the second communication interface 42. Accordingly, the card-form SSD or the module-form SSD with different kinds of interface specifications can be connected with the current interfaces available on the main circuit board of the computer by a user through the inventive composite storage device and the composite memory without adding any new interfaces on the main circuit board. Consequently, the facilities of utilizing and mounting the SSDs are improved, and the cost is reduced.

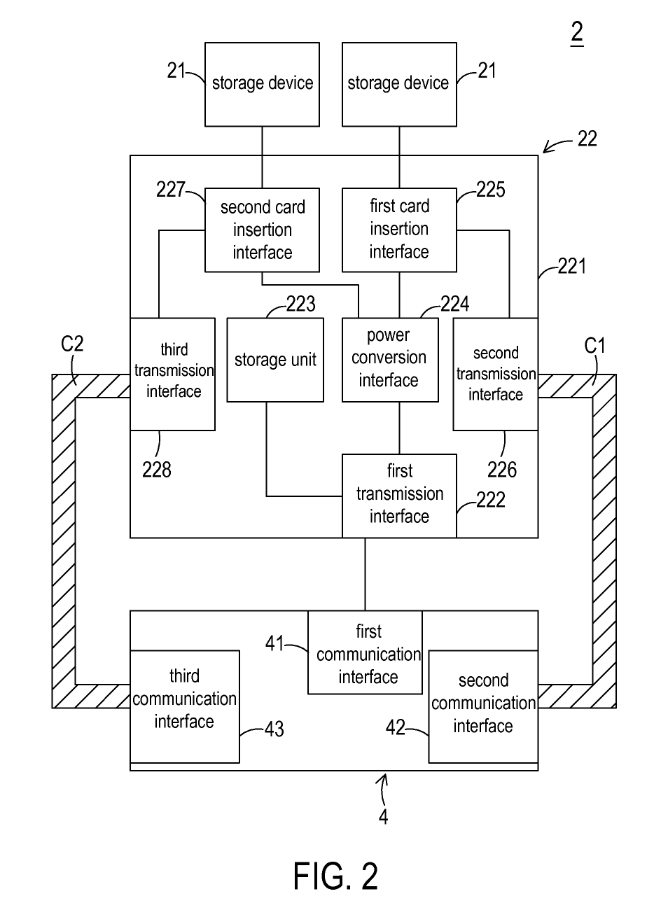

FIG. 2 schematically illustrates a composite storage device according to another embodiment of the present invention. Please refer to FIG. 2. Composite storage device 2 comprises two storage devices 21 and a composite memory 22. The composite memory 22 comprises a substrate 221, a first transmission interface 222, a storage unit 223, a power conversion unit 224, a first card insertion interface 225, a second transmission interface 226, a second card insertion interface 227 and a third transmission interface 228, wherein the first transmission interface 222, the storage unit 223, the power conversion unit 224, the first card insertion interface 225, the second transmission interface 226, the second card insertion interface 227 and the third transmission interface 228 are all disposed on the substrate 221. In this embodiment, the functions, connections and operations of the substrate 221, the first transmission interface 222, the storage unit 223, the power conversion unit 224, the first card insertion interface 225 and the second transmission interface 226 are similar with the substrate 121, the first transmission interface 122, the storage device 123, the power conversion unit 124, the card insertion interface 125 and the second transmission interface 126 of the embodiment shown in FIG. 1, respectively, and it is not redundantly described herein. In comparing the embodiment shown in FIG. 2 with the embodiment shown in FIG. 1, the composite memory 22 further comprises the second card insertion interface 227 and the third transmission interface 228. In this embodiment, the first card insertion interface 225 is coupled with the power conversion unit 224 and the second transmission interface 226, and the second card insertion interface 227 is coupled with the power conversion unit 224 and the third transmission interface 228. Under this circumstances, the composite memory 22 is capable of being connected with two storage devices 21 at the same time. Preferably, the first card insertion interface 225 and the second card insertion interface 227 are conformed to different kinds of interface specifications, so that two storage devices 21 with different kinds of interface specifications can be connected with the same composite memory 22 at the same time.

Please refer to FIG. 2 again. When the storage device 21 (i.e. a first storage device) is electrically connected with the first card insertion interface 225, the second power, which is converted by the power conversion unit 224 and conformed to the interface specification of the first card insertion interface 225, is outputted to the storage device 21 through the first card insertion interface 225. Consequently, the required electric energy can be provided to the storage device 21 for operations. In addition, when the storage device 21 is electrically connected with the first card insertion interface 225, the storage device 21 is connected with the main circuit board 4 through the first card insertion interface 225, the second transmission interface 226, the first transmission channel C1 and the second communication interface 42 of the main circuit board 4. Under this circumstances, information exchanged between the storage device 21 and the main circuit board 4 is performed via the transmission path of the first card insertion interface 225, the second transmission interface 226, the first transmission channel C1 and the second communication interface 42 of the main circuit board 4. Similarly, when the storage device 21 (i.e. a second storage device) is electrically connected with the second card insertion interface 227, the third power, which is converted by the power conversion unit 224 and conformed to the interface specification of the second card insertion interface 227, is outputted to the storage device 21 through the second card insertion interface 227. Consequently, the required electric energy can be provided to the storage device 21 for operations. In addition, when the storage device 21 is electrically connected with the second card insertion interface 227, the storage device 21 is connected with the main circuit board 4 through the second card insertion interface 227, the third transmission interface 228, the second transmission channel C2 and the third communication interface 43 of the main circuit board 4. Under this circumstances, information exchanged between the storage device 21 and the main circuit board 4 is performed via a transmission path of the second card insertion interface 227, the third transmission interface 228, the second transmission channel C2 and the third communication interface 43 of the main circuit board 4. In this embodiment, the second transmission interface 226 and the third transmission interface 228 of the composite memory 22 and the second communication interface 42 and the third communication interface 43 of the main circuit board 4 are conformed to the SATA interface specifications, but it is not limited thereto. In addition, the first transmission channel C1 and the second transmission channel C2 are cables that are conformed to the SATA interface specifications, but it is not limited thereto. Under this circumstances, at least one non-volatile storage device for example a SSD is integrated with a volatile storage unit for example a dynamic random access memory (DRAM), and the required electric energy can be provided to the SSD and the DRAM for operations via the current DRAM connection interface available on the main circuit board at the same time. Consequently, by employing the composite storage device and the composite memory of the present invention, various card-form SSD or module-form SSD can be coupled with the main circuit board, and the required electric energy can be provided to the SSD and the DRAM for operations at the same time via a single interface of the main circuit board.

From the above descriptions, the present disclosure provides a composite storage device and a composite memory thereof. By integrating at least one SSD with a DRAM, the SSDs with different kinds of interface specifications can be installed on the main circuit board of the computer through the current interfaces available on the main circuit board without adding any new interfaces on the main circuit board. Consequently, the facilities of utilizing and mounting the SSDs are improved, and the cost is reduced. In addition, by employing the composite storage device and the composite memory of the present invention, various card-form SSD or module-form SSD can be coupled with the main circuit board, and the required electric energy can be provided to the non-volatile storage device (i.e. the SSD) and the dynamic random access memory (i.e. DRAM) for operations at the same time via a single interface of the main circuit board. Consequently, the mounting space is reduced, and the size of the product can be further reduced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A composite storage device comprising:
a composite memory, comprising:
a substrate;
a first transmission interface disposed on the substrate and configured to connect with a first communication interface of a main circuit board;
a storage unit disposed on the substrate and coupled with the first transmission interface, wherein information is exchanged between the storage unit and the main circuit board through the first transmission interface and the first communication interface;
a power conversion unit disposed on the substrate and electrically coupled with the first transmission interface for converting a first power provided from the main circuit board to a second power;
a card insertion interface disposed on the substrate and coupled with the power conversion unit; and
a second transmission interface disposed on the substrate and coupled with the card insertion interface, wherein the second transmission interface is connected with a second communication interface of the main circuit board through a transmission channel; and
a storage device detachably connected with the card insertion interface of the composite memory, wherein when the storage device is electrically connected with the card insertion interface, the second power is provided to the storage device for operations through the card insertion interface, and the information is exchanged between the storage device and the main circuit board through the card insertion interface, the second transmission interface, the transmission channel and the second communication interface.

2. The composite storage device according to claim 1, wherein the storage device is a non-volatile storage device.

3. The composite storage device according to claim 1, wherein the storage unit is a volatile storage unit.

4. The composite storage device according to claim 1, wherein the card insertion interface is conformed to an mSATA interface specification, an M.2 interface specification or a CFast card interface specification.

5. The composite storage device according to claim 1, wherein the storage device is a Solid State Drive.

6. The composite storage device according to claim 5, wherein the Solid State Drive is conformed to an mSATA interface specification, an M.2 interface specification or a CFast card interface specification.

7. The composite storage device according to claim 1, wherein each of the second transmission interface and the second communication interface is conformed to a SATA interface specification.

8. The composite storage device according to claim 1, wherein each of the first transmission interface and the first communication interface is conformed to a dual in-line memory module interface specification.

9. The composite storage device according to claim 1, wherein the transmission channel is a cable.

10. A composite memory for detachably connecting with a storage device and a main circuit board including a first communication interface and a second communication interface, the composite memory comprising:
a substrate;
a first transmission interface disposed on the substrate and configured to connect with the first communication interface of the main circuit board;
a storage unit disposed on the substrate and coupled with the first transmission interface, wherein information is exchanged between the storage unit and the main circuit board through the first transmission interface and the first communication interface;
a power conversion unit disposed on the substrate and electrically coupled with the first transmission interface for converting a first power provided from the main circuit board to a second power;
a card insertion interface disposed on the substrate and coupled with the power conversion unit for detachably connecting with the storage device; and
a second transmission interface disposed on the substrate and coupled with the card insertion interface, wherein the second transmission interface is connected with the second communication interface of the main circuit board through a transmission channel,
wherein when the storage device is electrically connected with the card insertion interface, the second power is provided to the storage device for operations through the card insertion interface, and the information is exchanged between the storage device and the main circuit board through the card insertion interface, the second transmission interface, the transmission channel and the second communication interface.

11. A composite storage device comprising:
a composite memory, comprising:
a substrate;
a first transmission interface disposed on the substrate and configured to connect with a first communication interface of a main circuit board;
a storage unit disposed on the substrate and coupled with the first transmission interface, wherein information is exchanged between the storage unit and the main circuit board through the first transmission interface and the first communication interface;
a power conversion unit disposed on the substrate and coupled with the first transmission interface for converting a first power provided from the main circuit board to a second power and a third power;
a first card insertion interface disposed on the substrate and coupled with the power conversion unit;
a second card insertion interface disposed on the substrate and coupled with the power conversion unit;
a second transmission interface disposed on the substrate and coupled with the first card insertion interface, wherein the second transmission interface is connected with a second communication interface of the main circuit board through a first transmission channel; and
a third transmission interface disposed on the substrate and coupled with the second card insertion interface, wherein the third transmission interface is connected with a third communication interface of the main circuit board through a second transmission channel; and
at least one storage device, each of which is detachably connected with one of the first card insertion interface and the second card insertion interface;
wherein when the storage device is electrically connected with the first card insertion interface, the second power is provided to the storage device for operations through the first card insertion interface, and the information is exchanged between the storage device and the main circuit board through the first card insertion interface, the second transmission interface, the first transmission channel and the second communication interface, and wherein when the storage device is electrically connected with the second card insertion interface, the third power is provided to the storage device for operations through the second card insertion interface, and the information is exchanged between the storage device and the main circuit board through the second card insertion interface, the third transmission interface, the second transmission channel and the third communication interface.

12. The composite storage device according to claim 11, wherein the storage device is a non-volatile storage device.

13. The composite storage device according to claim 11, wherein the storage unit is a volatile storage unit.

14. The composite storage device according to claim 11, wherein each of the first card insertion interface and the second card insertion interface is conformed to an mSATA interface specification, an M.2 interface specification or a CFast card interface specification.

15. The composite storage device according to claim 11, wherein the storage device is a Solid State Drive.

16. The composite storage device according to claim 15, wherein the Solid State Drive is conformed to an mSATA interface specification, an M.2 interface specification or a CFast card interface specification.

17. The composite storage device according to claim 11, wherein each of the second transmission interface and the second communication interface is conformed to a SATA interface specification.

18. The composite storage device according to claim 11, wherein each of the third transmission interface and the third communication interface is conformed to a SATA interface specification.

19. The composite storage device according to claim 11, wherein each of the first transmission interface and the first communication interface is conformed to a dual in-line memory module interface specification.

20. The composite storage device according to claim 11, wherein each of the first transmission channel and the second transmission channel is a cable.
